(19) United States
(12) Patent Application Publication
(10) Pub. No.: US 2018/0158150 A1
(43) Pub. Date: Jun. 7, 2018

(54) METHOD, SYSTEM, AND DEVICE FOR ESTIMATING A COST OF ELECTRICITY PROVIDED TO AN ELECTRIC VEHICLE AT AN ELECTRIC VEHICLE CHARGER

(71) Applicant: Swtch E-Car Inc., Toronto (CA)

(72) Inventors: Carter Di Li, Toronto (CA); Michael James Gillespie, Toronto (CA)

(21) Appl. No.: 15/368,727

(22) Filed: Dec. 5, 2016

(51) Int. Cl. G06Q 50/06; G06Q 20/10; G06Q 30/02

(52) U.S. Cl. CPC G06Q 50/06; G06Q 30/0283; G06Q 20/102

(57) ABSTRACT

A method, system, and server for estimating a cost of electricity provided to an electric vehicle. At a server, obtaining a host geographical location and at least one charging time indicator associated with charging an electric vehicle at an electric vehicle charger. At the server, computing a price of electricity based on the host geographical location. At the server, absent a measurement of electricity provided to the electric vehicle, computing an estimated cost of the electricity provided to the electric vehicle based on one or more physical characteristics of a battery of the electric vehicle, the price of electricity and the at least one charging time indicator. Sending through a network the estimated cost of the electricity from the server towards a host computing device and a driver computing device.

### TECHNICAL FIELD

The present invention relates to electric vehicle charging and, more particularly, to electric vehicle charging at a host's premises.

### BACKGROUND

It is well known that there is a lack of commercial electric vehicle charging stations. Drivers of electric vehicles are therefore limited with regards to where and how far they can drive. One solution to this problem is for owners of electric vehicle chargers (the “hosts”) to share their personal chargers with the public, e.g., by listing them with an online service designed for this purpose. However, before accepting such listing, hosts require appropriate means for conditionally providing their private charger to the public.

The present invention addresses this challenge.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A first aspect of the invention is directed to a method for estimating a cost of electricity provided to an electric vehicle. The method comprises, at a server, obtaining a host geographical location and at least one charging time indicator associated with charging an electric vehicle at an electric vehicle charger, and storing the host geographical location and the at least one charging time indicator on a storage module of the server. The server computes at a processor of the server a price of electricity based on the host geographical location. The server, absent a measurement of electricity provided to the electric vehicle while charging at the electric vehicle charger, computes at the processor of the server an estimated cost of the electricity provided to the electric vehicle while charging at the electric vehicle charger based on one or more physical characteristics of a battery of the electric vehicle, the price of electricity and the at least one charging time indicator, wherein the one or more physical characteristics of the battery comprise at least one of a battery level before charging and a battery level after charging. The method further comprises determining a payment amount taking into consideration the estimated cost of electricity provided to the electric vehicle.

Optionally, the method comprises, from the server, sending, through a network interface of the server, the payment amount towards a host computing device for display on a user interface thereof. As another option, the method comprises, from the server, sending through the network interface the payment amount towards a driver computing device for display on a driver user interface thereof.

Optionally, the payment amount may be less than the estimated cost of electricity. Optionally, the payment amount may be equal to the estimated cost of electricity. Optionally, the payment amount may be greater than the estimated cost of electricity. Optionally, the payment amount may be equal to the estimated cost of electricity plus a host fee and a service provider fee.

Optionally, the at least one charging time indicator may comprise a check-in time corresponding to when the electric vehicle begins charging at the electric vehicle charger and a check-out time corresponding to when the electric vehicle stops charging at the electric vehicle charger. Optionally, the at least one charging time indicator may comprise a charging time corresponding to a time period between a check-in time of the electric vehicle at the electric vehicle charger and a check-out time of the electric vehicle at the electric vehicle charger.

Optionally, computing the price of electricity may further be based on a time of day at the host geographical location or a host energy consumption pattern applicable to a host. Optionally, computing the price of electricity may comprise retrieving the price of electricity from the storage module of the server.

As an option, the method may further comprise, at the server, processing using the processor of the server a payment equal to the payment amount from a driver associated with a driver computing device to a host associated with a host computing device.

As an option, the method may further comprise, at the server, receiving the one or more physical characteristics of the battery through the network interface and storing the one or more physical characteristics of the battery on the storage module, the one or more physical characteristics of the battery being provided to a driver computing device through a driver user interface thereof.

Optionally, the method may further comprise computing at the processor of the server the battery level after charging based on the battery level before charging, the at least one charging time indicator, and an estimated speed of charging of the electric vehicle.

Optionally, the method may further comprise receiving at the server through the network interface a make and model of the electric vehicle and an electric vehicle charger type and computing at the processor of the server the estimated speed of charging of the electric vehicle further considering the make and model of the electric vehicle and the electric vehicle charger type. As a further option, computing the estimated speed of charging may be performed based on a battery usage of the battery of the electric vehicle, the battery usage being received at the server through the network interface from a driver computing device. As another option, computing the estimated speed of charging may be performed based on a battery temperature of the battery of the electric vehicle, the battery temperature being received at the server through the network interface from a driver computing device.

Optionally, the driver computing device may be a driver mobile device. Optionally, the host computing device may be a host computer. Optionally, the host computing device may be a host mobile device.

Optionally, the estimated cost of the electricity provided to the electric vehicle may be computed using a function, the function being:

Cost Estimate=(Battery Level After−Battery Level Before)×Price of Electricity×Charging Time

Optionally, the estimated cost may be computed at the server by the processor using a function, the function being linear with respect to electricity provided, the electricity provided corresponding to the electricity level after charging minus the electricity level before charging. As another option, the estimated cost may be computed at the server by the processor using a function, the function being exponential with respect to electricity provided, the electricity provided corresponding to the electricity level after charging minus the electricity level before charging. As a further option, the estimated cost may be computed at the server by the processor using a function, the function being a step function with respect to electricity provided, the electricity provided corresponding to the electricity level after charging minus the electricity level before charging.

Optionally, the at least one charging time indicator comprises a first indicator that charging of the electric vehicle at the electric vehicle charger has started, a first time being associated therewith; a second indicator that charging of the electric vehicle at the electric vehicle charger has stopped, a second time being associated therewith, and a charging time computed by subtracting the first time from the second time.

A second aspect of the invention is directed to a server for estimating a cost of electricity provided to an electric vehicle. The server comprises a network interface module for interfacing with a host computing device and a driver computing device through a network. The network interface module obtains a host geographical location and at least one charging time indicator associated with charging an electric vehicle at an electric vehicle charger. The server further comprises a storage module for storing the host geographical location and the at least one charging time indicator. The server comprises a processor module for computing a price of electricity based on the host geographical location. The processor module further, absent a measurement of electricity provided to the electric vehicle while charging at the electric vehicle charger, computes an estimated cost of the electricity provided to the electric vehicle while charging at the electric vehicle charger based on one or more physical characteristics of a battery of the electric vehicle, the price of electricity and the at least one charging time indicator, wherein the one or more physical characteristics of the battery comprise at least one of a battery level before charging and a battery level after charging. The processor module further determines a payment amount taking into consideration the estimated cost of electricity provided to the electric vehicle.

Optionally, the network interface is further for sending the payment amount towards the host computing device for display on a user interface thereof. As another option, the network interface is further for sending the payment amount towards the driver computing device for display on a driver user interface thereof.

Optionally, the payment amount may be less than the estimated cost of electricity. Optionally, the payment amount may be equal to the estimated cost of electricity. Optionally, the payment amount may be greater than the estimated cost of electricity. Optionally, the payment amount may be equal to the estimated cost of electricity plus a host fee and a service provider fee.

Optionally, computing the price of electricity may further be based on a time of day at the host geographical location or a host energy consumption pattern applicable to a host. Optionally, computing the price of electricity may comprise retrieving the price of electricity from the storage module of the server.

Optionally, the processor module may further be for processing a payment equal to the payment amount from a driver associated with the driver computing device to a host associated with the host computing device.

Optionally, the network interface module may further be for receiving the one or more physical characteristics of the battery, the one or more physical characteristics of the battery being provided to the driver computing device through a driver user interface thereof.

Optionally, the at least one charging time indicator may comprise a first indicator that charging of the electric vehicle at the electric vehicle charger has started, a first time being associated therewith, a second indicator that charging of the electric vehicle at the electric vehicle charger has stopped, a second time being associated therewith, and a charging time computed by subtracting the first time from the second time.

A third aspect of the invention is directed to a system for estimating a cost of electricity provided to an electric vehicle. The system comprises a network comprising a server, a host computing device, and a driver computing device. The server obtains a host geographical location and at least one charging time indicator associated with charging an electric vehicle at an electric vehicle charger, and stores the host geographical location and the at least one charging time indicator on a storage module of the server. The server computes at a processor of the server a price of electricity based on the host geographical location. The server, absent a measurement of electricity provided to the electric vehicle while charging at the electric vehicle charger, computes at the processor of the server an estimated cost of the electricity provided to the electric vehicle while charging at the electric vehicle charger based on one or more physical characteristics of a battery of the electric vehicle, the price of electricity and the at least one charging time indicator, wherein the one or more physical characteristics of the battery comprise at least one of a battery level before charging and a battery level after charging. The server determines a payment amount taking into consideration the estimated cost of electricity provided to the electric vehicle.

Optionally, the server may send through a network interface of the server the payment amount towards the host computing device for display on a user interface thereof. Optionally, the server may send through the network interface of the server the payment amount to the driver computing device for display on a driver user interface thereof.

Optionally, the payment amount may be less than the estimated cost of electricity. Optionally, the payment amount may be equal to the estimated cost of electricity. Optionally, the payment amount may be greater than the estimated cost of electricity. Optionally, the payment amount may be equal to the estimated cost of electricity plus a host fee and a service provider fee.

Optionally, computing the price of electricity may further be based on a time of day at the host geographical location or a host energy consumption pattern applicable to a host. Optionally, computing the price of electricity may comprise retrieving the price of electricity from the storage module of the server.

Optionally, the server may process using the processor of the server a payment equal to the payment amount from a driver associated with the driver computing device to a host associated with the host computing device.

Optionally, the server may receive the one or more physical characteristics of the battery through the network interface and store the one or more physical characteristics of the battery on the storage module, the one or more physical characteristics of the battery being provided to the driver computing device through the driver user interface thereof.

Optionally, the at least one charging time indicator may comprise a first indicator that charging of the electric vehicle at the electric vehicle charger has started, a first time being associated therewith; a second indicator that charging of the electric vehicle at the electric vehicle charger has stopped, a second time being associated therewith; and a charging time computed by subtracting the first time from the second time.

### BRIEF DESCRIPTION OF THE DRAWINGS

Further features and exemplary advantages of the present invention will become apparent from the following detailed description, taken in conjunction with the appended drawings, in which:

FIG. 1 is a logical modular representation of an exemplary system comprising a server for estimating the cost of electricity provided to an electric vehicle, in accordance with the teachings of the present invention;

FIG. 2 is a flow chart of an exemplary method for estimating the cost of electricity provided to an electric vehicle, in accordance with the teachings of the present invention; and

FIG. 3 is a diagram of an exemplary personal location, in accordance with the teachings of the present invention.

### DETAILED DESCRIPTION

The host is defined as the user or users of the host computing device. Typically the host would be the owner of the private or personal electric vehicle charger at the personal or private location. The host may also further be the owner of the personal or private location. The host may also represent, in certain circumstances, more than one entity acting as a single point of contact (e.g., the host may collectively refer to an owner of the personal or private location and a renter of the personal or private location responsible for a personal or private charger installed thereat). Skilled persons will readily recognize that a manager or an intermediate management entity (e.g., renter, intermediary company, etc.) may also be the host, insofar as it contributes to the management of the electric vehicle charger through the host computing device. A skilled person will also recognize that there may be multiple host computing devices used by multiple users. For example, one user using a first host computing device may authorize the driver of the electric vehicle to receive electricity at the electric vehicle charger, while another user using a second host computing device may receive the payment from the driver. When reference to a location or an electric vehicle charger is made, and unless explicitly indicated otherwise, reference is made to a personal and/or private location or personal and/or private electric vehicle charger. For the sake of clarity, “personal” will be used hereinafter to qualify aspects of the solution related to personal and/or private.

The driver is defined as the user or users of the driver computing device. Typically, the driver will be the person driving the electric vehicle. Skilled persons will readily recognize, however, that there could be multiple users of the driver computing device. For example, a passenger in the car may use the driver computing device. Alternatively, a person external to the car may use the driver computing device. For example, if the car is a rental car, a designated person at the rental car company may be the user of the driver computing device for the purposes of authorizing payment to the host. Skilled persons will also readily recognize that there may be multiple driver computing devices used by multiple users. For example, a first user driving the electric vehicle may use a first driver computing device to locate an electric vehicle charger, while a second user using a second driver computing device may authorize the payment to the host for the electricity provided. Nonetheless, given that in the typical case the user of the drive computing device is the driver of the electric vehicle and further given that the driver of the electric vehicle will always have an integral role to play in charging the electric vehicle (namely, driving the electric vehicle to the charger), for the sake of simplicity we refer to the user or users of the driver computing device throughout the application as the “driver”.

In order to be effective, the solution needs to provide a compensation that associates a fair value to the service provided by the host to the driver of the electric vehicle. Ultimately, in order for the service to be successful, the host has to be compensated when an electric vehicle is charged thereat, meeting the expectations of the host as well as the driver of the electric vehicle. The service from the host includes the actual provision of the personal charger at the personal location (as it had to be somehow acquired and installed thereat) and, of course, also comprises providing electricity by the personal charger to the electric vehicle. The service may also comprise access to the physical location of the charger (e.g., simple parking location and/or enhanced security measures in the vicinity of the charger).

A challenge faced in developing an appropriate solution is associating a fair value to the electricity provided by the personal charger to the electric vehicle. A known way of associating such fair value is to measure the actual amount of energy transferred from the personal charger to the electric vehicle. A metering device is required between the personal electric vehicle charger and the electric vehicle to measure the amount of energy provided. Typically, the measure of energy is expressed in kilowatt hour (kWh) of electricity, which is then also typically used as a billing unit by electric utility companies (e.g., home owners are charged anywhere between 4¢ and 35¢ per kWh). A kWh of electricity is equal to 3.6 megajoules and, therefore, ultimately represents an amount of energy. Measuring the actual amount of energy transferred has a number of disadvantages. It is costly and inconvenient for the host to add a metering device to the personal electric vehicle charger and/or for the driver of the electric vehicle to equip the electric vehicle with a metering device. Reliability of the metering device may also be questioned by the host and/or by the driver of the electric vehicle that does not provide the metering device. If both the host and the driver of the electric vehicle provide a metering device, then a reconciliation solution would likely be required between the two measurements. Considering the costs and inconvenience associated with the use of a metering device, it is expected that fewer hosts would be willing to share their personal electric vehicle chargers with the public. An online service that would allow hosts to be put in touch with drivers of electric vehicle would consequently be less useful as the service offering from the hosts would not be sufficient.

Generally, embodiments of the present invention calculate the compensation to the host from the driver of the electric vehicle considering an estimation of the amount of electricity provided thereto instead of an actual measurement. As such, in the context of the present invention, the actual amount of electricity provided to the electric vehicle does not have to be measured. For the reasons provided herein above, it is even suggested that the amount of electricity not be measured during the charge. Of course, nothing prevents an actual measure of electricity to be taken, but the present invention does not require such measurement. Instead of requiring an actual measurement, the server calculates a cost estimate of the electricity provided to the electric vehicle based on a variety of factors. The compensation is an amount paid from the driver of the electric vehicle to the host. The amount is based on the estimated cost of the electricity provided to the driver's electric vehicle and may be supplemented with an additional service fee for the service provided (e.g., fixed fee, %, or a mix of both charged by the online service provider) and/or a service fee for the host (e.g., fixed fee, %, or a mix of both charged by the host as a location and/or charger provisioning fee).

In one embodiment in accordance with the teachings of the present invention, a host enters into a user interface of a host computing device a number of available timeslots during which drivers may charge their electric vehicles at the host's electric vehicle charger. The host further enters into the user interface charger access information to enable drivers to access the host's electric vehicle charger. The host computing device sends the timeslots and the charger access information towards a server via a network, preferably the Internet. The host may either enable automatic check-in approval or manual check-in approval. A driver of an electric vehicle searches for available electric vehicle chargers within a specified geographic area using a driver computing device. The driver computing device uses GPS to determine the driver's geographical location and retrieves the available electric vehicle chargers in the area from the server via the network. The driver identifies an available personal electric vehicle charger and reserves the timeslot with the server. The server may then convey some or all relevant information of the driver of the electric vehicle to the host. The driver arrives at the electric vehicle charger and checks-in to the reserved timeslot. If the host has enabled automatic check-in approval, the server automatically sends the charger access information to the driver computing device. Alternatively, if the host has enabled manual check-in approval, a driver check-in request is sent to the host computing device. Once the host approves the check-in request (e.g., matching information previously received from the server with information directly or indirectly provided by the driver of the electric vehicle), the server sends the charger access information to the driver computing device. The driver gains physical access to the electric vehicle charger and scans a QR code on the electric vehicle charger to initiate the charging transaction. When charging of the electric vehicle is complete, the driver checks-out of the electric vehicle charger via the driver computing device. It is important to note that, in the context of the present invention, the amount of electricity provided to the electric vehicle does not have to be measured. For the reasons provided herein above, it is even suggested that the amount of electricity not be measured. While charging the electric vehicle. Instead of having an actual measurement, the server calculates a cost estimate of the electricity provided to the electric vehicle based on a variety of factors, which may include the make and model of the electric vehicle, the electric vehicle charger type, the battery level, the battery usage, the geographical location of the host, the time of day that the charging took place, the energy consumption habits of the host, and the charging time. The server processes a payment from the driver to the host, using banking information provided by the driver and the host. The amount of the payment is based on the estimated cost of the electricity provided to the driver's electric vehicle. The amount of the payment may be less than the estimated cost of electricity, for example in the case of a rebate. Alternatively, the amount of the payment may be equal to the estimated cost of electricity. Alternatively, the amount of the payment may be greater than the estimated cost of electricity. For example, the amount of the payment may be supplemented by an additional service fee for the online service provider as well as a host provider fee for the host.

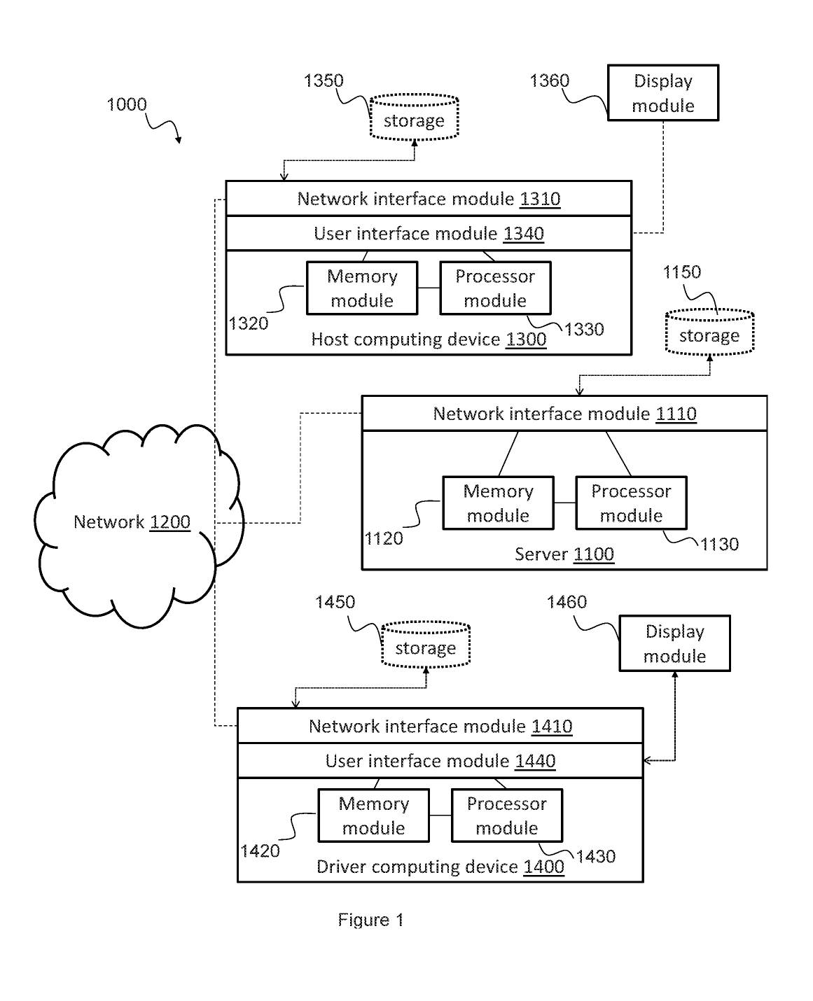

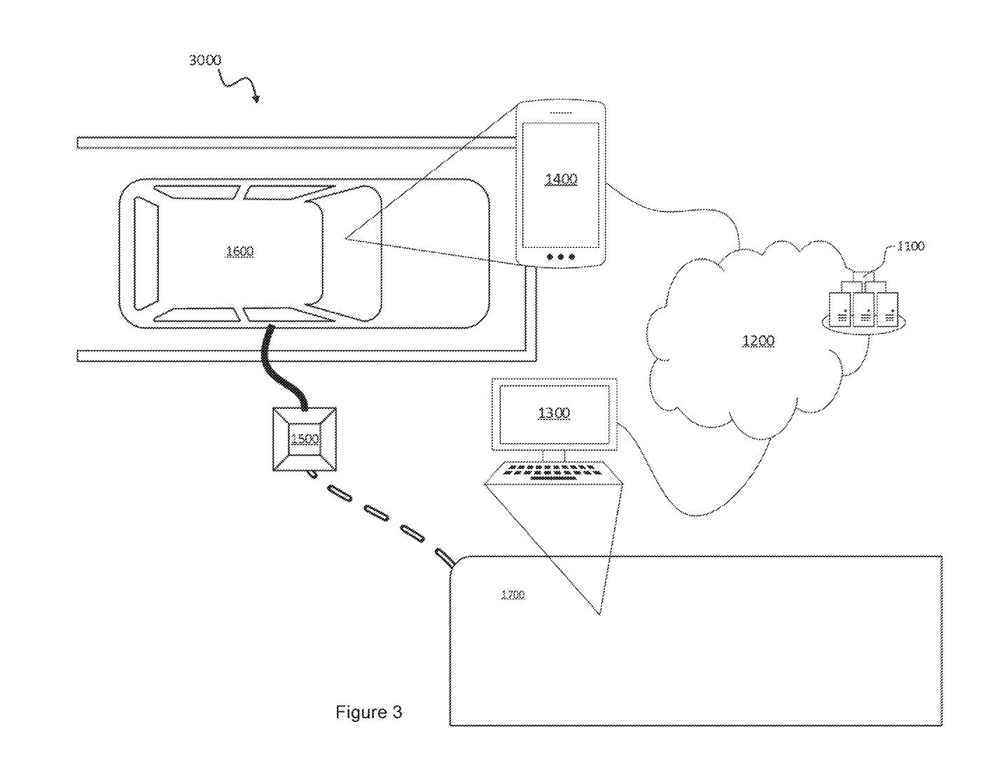

Reference is made to the drawings in which FIG. 1 shows a logical modular representation of an exemplary system 1000 in accordance with the teachings of the present invention. FIG. 3 shows a diagram of an exemplary personal location 3000. Reference is made concurrently to FIG. 1 and FIG. 3. The system 1000 comprises a server 1100 for estimating a cost of electricity provided to an electric vehicle 1600 through a personal electric vehicle charger 1500 from an electricity source 1700. In the depicted example, the electricity source 1700 is a personal home or the like connected to the electricity grid of an electric utility company (not shown). Skilled persons will recognize that the electricity source may also comprise an auxiliary power generator (not shown) that is meant to provide power continuously (e.g., solar panel array, wind turbine) or temporarily (e.g., gasoline backup generator). The server 1100 comprises a memory module 1120, a processor module 1130, a network interface module 1110, and a storage module 1150. The storage module 1150 may be a standard hard disk drive, a solid state drive, a tape drive, RAID storage, or any form of non-volatile memory that meets the various requirements for storing and retrieving the host geographical location, the at least one charging time indicator, and other information, such as the personal information of the host and the driver, the payment information of the host and driver, the make and model of the driver's electric vehicle, and the type of the host's electric vehicle charger. The storage module 1150 may be externally connected to the server 1100. The storage module 1150 may be a remote network storage connected to the server 1100 via the network 1200 (not shown). Alternatively, the storage module 1150 may be integrated with the server 1100 (not shown).

The system 1000 also comprises a host computing device 1300 and a driver computing device 1400, which may be personal computers, laptops, tablets, or mobile devices. The driver computing device 1400 may further be a computing device integrated in the electric vehicle (not explicitly shown). The host computing device 1300 comprises a memory module 1320, a processor module 1330, a network interface module 1310, and a storage module 1350. The storage module 1350 may be a standard hard disk drive, a solid state drive, a tape drive, RAID storage, or any form of non-volatile memory that meets the various requirements of this system 1000. The storage module 1350 may be externally connected to the host computing device 1300. The storage module 1350 may be a remote network storage connected to the host computing device 1300 via the network 1200 (not shown). Alternatively, the storage module 1350 may be integrated with the host computing device 1300 (not shown). The host computing device further comprises a display module 1360, which may be a remote display device connected to the host computing device 1300 or an integrated display device (not explicitly shown). The driver computing device 1400 comprises a memory module 1420, a processor module 1430, a network interface module 1410, and a storage module 1450. The storage module 1450 may be a standard hard disk drive, a solid state drive, a tape drive, RAID storage, or any form of non-volatile memory that meets the various requirements of this system 1000. The storage module 1450 may be externally connected to the driver computing device 1400. The storage module 1450 may be a remote network storage connected to the driver computing device 1400 via the network 1200 (not shown). Alternatively, the storage module 1450 may be integrated with the driver computing device 1400 (not shown). The driver computing device 1400 further comprises a display module 1460, which may be a remote display device connected to the driver computing device 1400 or an integrated display device (not explicitly shown).

The system 1000 further comprises a network 1200 for connecting the server 1100, the host computing device 1300, and the driver computing device 1400. Communication over the network 1200 may occur using TCP/IP and Ethernet or ATM SONET/SDNET over air, copper wires, optical fiber, or any other physical support capable of carrying data. In one embodiment, the server 1100 acts as an intermediary between the host computing device 1300 and the driver computing device 1400. For instance, the server 1100 and the host computing device 1300 are connected via the network 1200 and the server 1100 and the driver computing device 1400 are connected via the network 1200. Alternatively, the host computing device 1300 and the driver computing device 1400 may be directly connected to one another via the network 1200. In one embodiment, the network 1200 is the Internet. The driver computing device 1400 may be connected to the network 1200 in a variety of ways, such as via a cellular network, via Wi-Fi provided by the host, via Wi-Fi provided by the electric vehicle, or via Bluetooth provided by the electric vehicle. A skilled person will understand that the server 1100 may comprise multiple servers 1100 in a cluster or other similar shared-processing or distributed-processing architectures, whether in a single location or over cloud computing.

The server 1100, as intermediary, provides an online service to the host on the host computing device 1300 and the driver on the driver computing device 1400. The online service may consist of a web application and/or mobile app and/or standard desktop application. The online service may provide a login user interface to the host and to the driver, wherein the host and driver can provide a username and password to gain access to the online service. The online service may provide to the host and the driver an initial registration user interface to enter personal information, payment or banking information, and select a username and password. The online service may provide a user interface to the driver to locate an electric vehicle charger within a given geographical area. For example, the user interface may comprise a map of the geographical area with the locations of the electric vehicle chargers identified on the map using a recognizable icon. The online service may provide a user interface to the host to enter timeslots during which the electric vehicle charger is available to drivers of electric vehicles. The online service may provide a user interface to the driver and/or the host to indicate that charging of the electric vehicle has started and that charging of the electric vehicle has stopped. The online service may provide a user interface to the driver and the host to indicate the payment amount to be paid by the driver to the host. The online service may provide a user interface to process a payment from the driver to the host. The online service may provide a user interface to enable the host and/or the driver to send a message to the online service. The online service may provide a user interface to enable the host and/or driver to send messages to one another.

The online service provided by the server 1100 may provide a number of security measures to prevent the driver and the host from conspiring to avoid paying the online service provider the service provider fee. A skilled person will readily understand that once the driver and the host have been matched using the online service, they may try to continue the transaction amongst themselves without involving the online service in order to avoid paying the service provider fee. That is, the host uses the online service to make the host's electric vehicle charger available to the public, and the driver uses the online service to locate the host's electric vehicle charger, but once the driver arrives at the host's location, they stop using the online service. The host provides electricity to the driver's electric vehicle, but they do not use the online service to estimate the cost of the electricity or to process the payment from the driver to the host. The online service may take different security measures to prevent this from happening. For example, once the driver has used the online service to locate and check into a host, and the online service determines that the driver's electric vehicle went to the host's geographical location (e.g., based on the known civic address of the host and a GPS module of the driver computing device 1400), the online service provider can charge a penalty fee to the driver and/or the host if they fail to use the online service to complete the transaction. The penalty fee may be equal to the standard fixed service fee. Alternatively, if the service fee varies depending on the amount of electricity provided, the penalty fee may be equal to an average or a maximum of the service fees charged in the past.

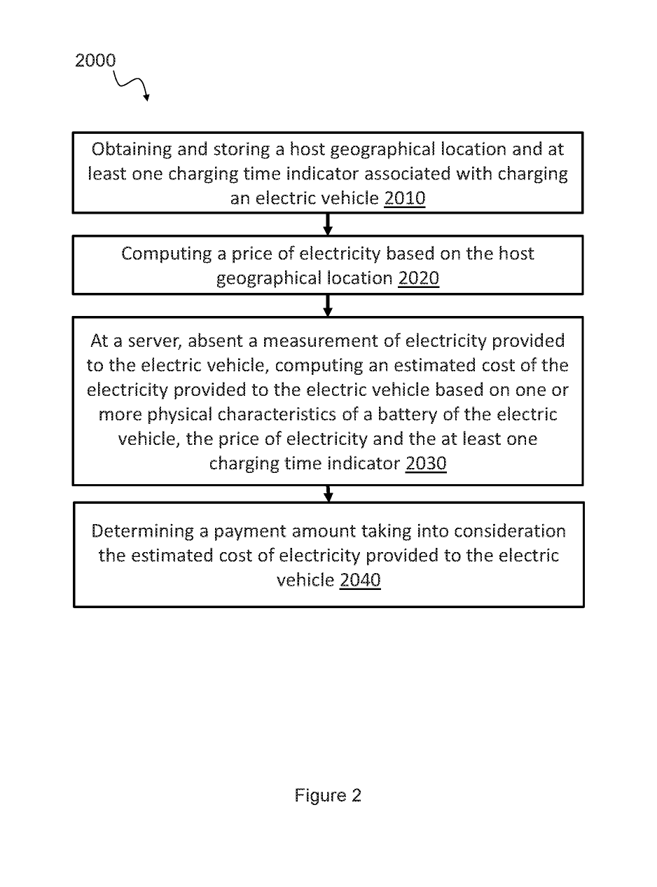

Reference is now made concurrently to FIG. 1, FIG. 3 and FIG. 2, which shows a flow chart of an exemplary method 2000 for estimating a cost of electricity provided to an electric vehicle 1600. The method 2000 comprises, at the server 1100, obtaining 2010 a host geographical location and at least one charging time indicator associated with charging an electric vehicle 1600 at an electric vehicle charger 1500, and storing the host geographical location and the at least one charging time indicator on the storage module 1150 of the server 1100. A skilled person will understand that the price of electricity varies across geographic locations. To form a reasonable estimate of the price of electricity, the server 1100 takes into account the geographical location of the electric vehicle charger 1500. The geographical location may for instance be a country, state, province, or city (e.g., derived from a civic address). The host may enter into the host computing device 1300 the geographical location of the electric vehicle charger 1500 during an initial registration process. Alternatively, the host computing device 1300 may automatically determine its geographical location. For example, the host computing device 1300 may be connected to or integrated with a GPS module for determining the geographical location. The host computing device 1300 then sends the geographical location to the server 1100 for storage on the storage module 1150. Alternatively, the geographical location of the electric vehicle charger 1500 may be requested by the server 1100 from the host computing device 1300 each time an electric vehicle 1600 charges at the host's electric vehicle charger 1500 rather than during an initial registration process.

The at least one charging time indicator may be determined at the driver computing device 1400. The driver may indicate to the driver computing device 1400 that charging of the electric vehicle 1600 has started by checking in or by scanning a QR code on the electric vehicle charger 1500. The driver may then indicate to the driver computing device 1400 that charging of the electric vehicle 1600 has stopped by checking out. Alternatively, the driver computing device 1400 may estimate the charging start time and charging stop time based on the geographical location of the electric vehicle 1600 using a GPS module integrated with either the driver computing device 1400 or the electric vehicle 1600. For example, the driver computing device 1400 could assume that charging has started when the electric vehicle 1600 is within 10 meters of the electric vehicle charger 1500, and the driver computing device 1400 could assume that charging has stopped when the electric vehicle 1600 moves farther than 10 meters away from the electric vehicle charger 1500. The driver computing device 1400 calculates the charging time that the electric vehicle 1600 was charging at the electric vehicle charger 1500 and sends the charging time to the server 1100 via the network 1200. Alternatively, the driver computing device may send the charging start time and the charging stop time to the server 1100 via the network 1200, and the server 1100 calculates the charging time that the electric vehicle 1600 was charging at the electric vehicle charger 1500 based on the charging start time and the charging stop time. Alternatively, the driver computing device 1400 may be integrated with or connected to the electric vehicle 1600 such that it is able to automatically determine the charging start time and charging stop time and/or the duration of charging. Alternatively, the host computing device 1300 may be integrated with or connected to the electric vehicle charger 1500 and able to automatically determine the charging start time and charging stop time and/or the duration of charging (e.g., considering actual connection and disconnection times of the electric vehicle 1600, considering proximity detection of the electric vehicle 1600, considering location information of the electric vehicle 1600, etc.). In this case, the host computing device 1300 sends the at least one charging time indicator (e.g., the charging start time and charging stop time and/or the duration of charging) to the server 1100 via the network 1200.

The method 2000 further comprises computing 2020, at a processor 1130 of the server 1100, a price of electricity based on the host geographical location. A skilled person will understand that the price of electricity may be expressed as dollars per kWh. Computing 2020 the price of electricity based on the host geographical location may comprise setting the price of electricity to a default or static value. The geographical location may provide a single location-based reference to the price of electricity for the geographical location (e.g., uniform pricing for a city, state or province). However, in some cases, multiple references may be provided (e.g., different pricing for different cities in a state). Computing 2020 the price of electricity may then comprise looking up one or more prices of electricity associated with the single location-based reference or the multiple references in a lookup table stored on the storage module 1150 of the server 1100. When multiple references are used, computing 2020 the price of electricity further comprises determining the price of electricity from the multiple references, which may be performed, for instance, by selecting the highest value, computing the means value, selecting the lowest reference value or asking the host to select a value in the range between the lowest and the highest values. Computing 2020 the price of electricity may also comprise retrieving the actual price of electricity for the host from a remote server operated by the electricity provided (not shown) via the network 1200. Alternatively, computing 2020 the price of electricity may comprise looking up the actual price of electricity for the host in a database of prices stored on the storage module 1150 of the server 1100, where this database of actual electricity prices is updated in real-time with electricity prices from the electricity provider. Alternatively, the host may generate electricity (e.g., using solar panels or an auxiliary power generator) rather than receive electricity from an electricity provider. In this case, the host may enter the price of electricity into a user interface 1340 of the host computing device 1300, which sends the price of electricity towards the server 1100 through the network 1200.

The method 2000 further comprises, at the server 1100, absent a measurement of electricity provided to the electric vehicle 1600 while charging at the electric vehicle charger 1500, computing 2030 at the processor 1130 of the server 1100 an estimated cost of the electricity provided to the electric vehicle 1600 while charging at the electric vehicle charger 1500 based on one or more physical characteristics of a battery of the electric vehicle 1600, the price of electricity and the at least one charging time indicator. The one or more physical characteristics of the battery comprise at least one of a battery level before charging and a battery level after charging. As will be recalled, one challenge faced in the development of the solution is to estimate, in an efficient and cost-effective way, the cost of electricity provided by a host's electric vehicle charger 1500 to a driver's electric vehicle 1600 so that the driver can compensate the host for the electricity provided (at least). The standard solution would be to use a physical metering device at the electric vehicle charger 1500 to measure the amount of electricity provided. The proposed solution instead uses a number of factors to estimate the amount of electricity provided to the electric vehicle 1600 and thereby estimate the cost of that electricity to the host within a reasonable margin of error. Exemplary advantages of this solution include avoiding the cost and inconvenience of adding a physical metering device to the electric vehicle charger 1500 and making the solution compatible with different combinations of electric vehicle 1600/electric vehicle charger 1500 not considering presence of a metering device as a requirement. It is assumed that hosts would be less likely to adhere to an online service if they had to spend money and/or time modifying or confirming their electric vehicle charger 1500 to specifications of a physical metering device. Moreover, it is intrinsic to the proposed solution that the cost will be within a margin of error. Yet, both hosts and drivers will tolerate the same margin of error in the cost estimate for the electricity provided. Furthermore, in some embodiments, the factors used for the estimation may be made available to the hosts and to the drivers in order for them to completely and transparently accept the applicable factors. The margin of error is the difference between the estimated cost of the electricity and the actual cost of the electricity to the host if it had been properly measured. A reasonable margin of error may be +/−5%. Alternatively, a reasonable margin of error may be +/−10%. However, hosts and drivers would be unlikely to tolerate a margin of error of +/−30% or more.

Optionally, the formula used to compute 2030 the estimated cost of the electricity provided is the following:

Cost Estimate=(Battery Level After−Battery Level Before)×Price of Electricity×Charging Time

The Battery Level After variable stands for the charge level of the battery upon completion of charging of the battery level. The Battery Level Before variable stands for the charge level of the battery before the charging of the electric vehicle 1600. The Price of Electricity variable stands for the computed 2020 price of electricity for the host for the geographical location, as specified above. The Charging Time variable stands for the actual or estimated charging time, which is received or computed at the server 1100, as specified above. The Battery Level Before and the Battery Level After may be read off the instrument panel of the electric vehicle 1600 and manually entered into the driver computing device 1400 by the driver. Alternatively, the driver computing device 1400 may be connected to or integrated with the electric vehicle 1600 such that it can automatically read the Battery Level Before and the Battery Level After. In either case, the driver computing device 1400 then sends the Battery Level Before and the Battery Level After to the server 1100 via the network 1200. Alternatively, the host computing device 1300 may be connected to the electric vehicle charger 1500, which is connected to the electric vehicle's battery (not explicitly shown), such that the host computing device 1300 can automatically determine the Battery Level Before and the Battery Level After. As another alternative, the electric vehicle charger 1500, which is connected to the electric vehicle's battery, may be able to determine the Battery Level Before and the Battery Level After and display said battery levels on a display module (not shown) of the electric vehicle charger 1500. The host and/or driver can then read off the battery levels from the electric vehicle charger 1500 and manually enter them into the host computing device 1300 or driver computing device 1400. In either case, the host computing device 1300 or driver computing device 1400 can then send the Battery Level Before and the Battery Level After to the server 1100 via the network 1200.

Alternatively, either the Battery Level Before or the Battery Level After may be estimated rather than read, either manually or automatically, from the electric vehicle's battery. For example, a skilled person will understand that the charging speed of the battery of the electric vehicle 1600 can be estimated based on one or more of the make and model of the electric vehicle 1600, the battery type, the usage of the battery, the temperature of the battery, and the type of electric vehicle charger 1500. The make and model of the electric vehicle 1600, the battery type, the usage of the battery, and the temperature of the battery may be manually entered into the driver computing device 1400 by the driver and sent to the server 1100 via the network 1200. Or, the make and model of the electric vehicle 1600, the battery type, the usage of the battery, and the temperature of the battery may be automatically determined by the driver computing device 1400 if it is integrated with or connected to the electric vehicle 1600. The type of electric vehicle charger 1500 may be manually entered by the host into the host computing device 1300 and sent towards the server 1100 via the network 1200. Or, the type of electric vehicle charger may be automatically determined by the host computing device 1300 if it is connected to the electric vehicle charger 1500. Given the Battery Level Before, the charging speed, and the Charging Time, the Battery Level After can be calculated. Likewise, given the Battery Level After, the charging speed, and the Charging Time, the Battery Level Before can be calculated.

The method 2000 further comprises, determining 2040 a payment amount taking into consideration the estimated cost of electricity provided to the electric vehicle. The payment amount is the amount that the driver pays to the host for receiving electricity at the host's electric vehicle charger. Part of the payment amount may also go to the online service provider. The payment amount may be less than the estimated cost of electricity. For example, the online service provider may offer a rebate to the driver, whereby the driver pays less than the estimated cost of electricity and the online service provider makes up the difference to the host. As an alternative example, the host may offer the rebate to the driver. The payment amount may be equal to the estimated cost of electricity. As another alternative, the payment amount may be greater than the estimated cost of electricity. For example, the payment amount may include a service fee for the online service provider and/or a host provider fee for the host. The service fee and the host provider fee may be fixed fees that are simply added to the estimated cost of electricity. Alternatively, the service fee and host provider fee may be expressed as percentages that are then multiplied by the estimated cost of electricity so that the amount of the fees depends on the estimated cost of electricity.

Optionally, the method 2000 may further comprise, from the server 1100, sending, through a network interface 1110 of the server 1100, the payment amount towards a host computing device 1300 for display on a user interface thereof 1340. Optionally, the method 2000 may also comprise, from the server 1100, sending through the network interface 1110 the payment amount towards a driver computing device 1400 for display on a driver user interface thereof 1440. Once the server 1100 has computed the estimated cost of electricity provided to the electric vehicle 1600, the server 1100 sends the payment amount to the host computing device 1300 and the driver computing device 1400. The payment amount is then displayed in a user interface on each of the host computing device 1300 and the driver computing device 1400. The payment amount may be displayed in a proprietary application or may be sent by email or text message. Alternatively, the payment amount may be sent to only one of either the host computing device 1300 or the driver computing device 1400. Alternatively, the payment amount sent to the host computing device 1300 may be different from the payment amount sent to the driver computing device 1400. As another alternative, a message indicating that the transaction is complete is sent to the host computing device 1300 and/or the driver computing device 1400, wherein this message does not specify the payment amount. The message may, for example, contain a URL to a web page that contains the payment amount. As another alternative, no message or payment amount may be sent to the host computing device 1300 or the driver computing device 1400 at the conclusion of the transaction. Instead, a message containing the payment amount may later be sent to the person responsible for paying for the electricity provided to the electric vehicle. A single such message may be sent for each transaction or alternatively a message containing the payment amounts for one or more transactions may be sent periodically (e.g., once per day, month, or year). Alternatively, a message containing the payment amounts for one or more transactions may be sent when a specific condition is satisfied. For example, such a message may be sent when the amount owed by the driver or the amount owed to the host reaches a threshold (e.g., $50). Alternatively, a message containing the payment amounts for one or more transactions may be sent to the host and/or the driver upon request by either the host or the driver. Likewise, a message containing a record of past transactions may be sent to the host and/or the driver. Alternatively, the online service provider may provide a user interface where the driver and/or the host can see all past transactions and settle those transactions that have not yet been paid for.

Optionally, the charging time indicator may comprise a check-in time corresponding to when the electric vehicle 1600 begins charging at the electric vehicle charger 1500 and a check-out time corresponding to when the electric vehicle 1600 stops charging at the electric vehicle charger 1500. As discussed above, the check-in time and check-out time are automatically determined or manually received at the driver computing device 1400 or the host computing device 1300, and then sent towards the server 1100 via the network 1200. Once the check-in and check-out times are received at the server 1100, the processor 1130 of the server 1100 computes the difference between the check-in time and the check-out time to determine the charging time of the electric vehicle 1600 at the electric vehicle charger 1500. Alternatively, the at least one charging time indicator may comprise a first notification when charging has begun (with or without containing the time) and a second notification when charging has stopped (also with or without containing the time). The server 1100 simply notes the charging start time when it receives the first notification and the charging stop time when it receives the second notification using the server's 1100 own internal clock, and then the server computes the charging time as the difference between the charging start time and the charging stop time. A skilled person will understand that the clock at the server 1100 does not need to have the same time as the clock at the driver computing device 1400 or the host computing device 1300 because a time difference is being calculated.

As an optional alternative, the charging time indicator may comprise a charging time corresponding to a time period between a check-in time of the electric vehicle 1600 at the electric vehicle charger 1500 and a check-out time of the electric vehicle 1600 at the electric vehicle charger 1500. As discussed above, the check-in time and the check-out time are automatically determined or manually entered at either the driver computing device 1400 or the host computing device 1300. The driver computing device 1400 or the host computing device 1300, as the case may be, computes the time period between the check-in time and the check-out time and then sends this time period corresponding to the duration of charging to the server 1100 via the network 1200.

Optionally, computing 2030 the price of electricity may further be based on a time of day at the location 3000 or a host energy consumption pattern applicable to a host. A skilled person will understand that the price of electricity may be dynamic within a particular geographic location such that it changes depending on a number of factors, such as time of day, the amount of electricity used and/or outside temperature. If this is the case, computing the price of electricity may comprise using a model to estimate the price of electricity for the host based on the relevant factors. For example, the price of electricity might vary depending on the amount of electricity used within a given time period (generally the billing period, such as a month). That is, there is a first price if the host uses less than a certain threshold T of electricity within the given time period, and a second price if the host uses more than T within the given time period. During an initial registration process, the host provides to the host computing device 1300 the amount the host typically spends on electricity. The host computing device 1300 sends this amount to the server 1100 via the network 1200. The server 1100 uses this amount to estimate the host's energy consumption pattern. Computing the price of electricity at the server 1100 comprises using a model to estimate whether the host's usage of electricity has exceeded the threshold T taking into account the host's energy consumption pattern and the number of electric vehicles that have received electricity from the host's electric vehicle charger 1500 within the relevant time period. Alternatively, or in addition, the price of electricity might depend on the time of day. That is, there is a first price during a certain time of the day (e.g., during peak usage of electricity) and a second price during the rest of the day (e.g., during non-peak usage of electricity). Alternatively, or in addition, the price of electricity might depend on the outside temperature. That is, there is a first price above a certain temperature threshold (e.g., above −10° C.) and a second price below the threshold (e.g., below −10° C.). In this case, computing 2020 the price of electricity may further comprise determining the price of electricity based on time of day and/or outside temperature in the geographical location of the host computing device 1300. In some embodiments, presence of an auxiliary power generator (not shown) at the location 3000 of the electric vehicle charger 1500 and the source of electricity 1700 may be taken into account to determine the price of electricity. For instance, when an auxiliary power generator is present, the server 1100 may be made aware of characteristics of such auxiliary power generator, which may then be used to adjust the price of electricity. For instance, the cost per kWh may be increased or decreased in real-time, or real-time priority processing, considering electricity currently being generated and/or may be fixed up to a certain amperage demand by the electric vehicle 1600 considering the auxiliary power generator nominal or actual power output before varying considering the grid characteristics, etc.). A skilled person will understand that there could be a multitude of different prices associated with a multitude of different electricity usage thresholds, and a multitude of electricity prices associated with a multitude of different times of day. It is also possible that the price of electricity within a given geographic location could depend on any permutations of the time of day, the amount of electricity used by the host and the outside temperature.

Optionally, computing 2030 the price of electricity may comprise retrieving the price of electricity from the storage module 1150 of the server 1100. If the electric vehicle 1600 charging service is only offered in a single geographic location, or if it is offered in multiple geographic locations where the prices of electricity are the same or similar, the price of electricity may be a default or static value stored on the storage module 1150 of the server 1100. Alternatively, computing 2020 the price of electricity may comprise looking up a price of electricity associated with a particular geographic location in a lookup table stored on the storage module 1150 of the server 1100. Alternatively, the server 1100 may maintain on the storage module 1150 a database of real-time electricity prices that are updated by the electricity provider, such that computing the price of electricity comprises looking up the price of electricity for the host in this database.

Optionally, the method 2000 may further comprise, at the server 1100, processing (not shown) using the processor 1130 of the server 1100 a payment from a driver associated with the driver computing device 1400 to a host associated with the host computing device 1300. The payment is determined taking into consideration the estimated cost of electricity provided to the electric vehicle 1600. The payment information for the host is received at the host computing device 1300, and the payment information for the driver is received at the driver computing device 1400. The payment information is sent from the host computing device 1300 and the driver computing device 1400 to the server 1100 through the network 1200 and stored on the storage module 1150 of the server 1100. The payment information may be received during an initial registration process. Alternatively, the payment information may be received anew for each transaction, for example, once the charging is complete and the cost estimate has been computed and delivered to the host and the driver. The server 1100 processes the payment by sending a command to initiate the payment through the network 1200 to a server (not shown) operated by a third party payment processor such as a bank, credit card company, PayPal, or other financial institution. The server 1100 may then receive confirmation of the payment from the third party server via the network 1200. The server 1100 may then send a receipt of the payment towards the host computing device 1300 and the driver computing device 1400 via the network 1200. Alternatively, the server 1100 may not process the payment from the driver to the host. Instead, the server 1100 sends the estimated cost to both parties and lets the parties settle the payment amongst themselves. The server 1100 receives confirmation of the payment from the driver computing device 1400 and the host computing device 1300 via the network 1200.

Optionally, the method 2000 may further comprise, at the server 1100, receiving (not shown) the one or more physical characteristics of the battery through the network interface 1110 and storing the one or more physical characteristics of the battery on the storage module 1150, the one or more physical characteristics of the battery being provided to the driver computing device 1400 through the driver user interface thereof 1460. The one or more physical characteristics of the batter comprise the Battery Level Before, the Battery Level After, the battery type, the usage of the battery, and the temperature of the battery. The driver reads off the physical characteristics of the battery from the display panel of the electric vehicle 1600 and enters them into the driver computing device 1400. The driver computing device 1400 sends the physical characteristics of the battery to the server 1100 via the network 1200.

Optionally, the method 2000 may further comprise computing (not shown) at the processor 1130 of the server 1100 the battery level after charging based on the battery level before charging, the at least one charging time indicator, and an estimated speed of charging of the electric vehicle 1600.

Optionally, the method 2000 may further comprise (not shown) receiving at the server 1100 through the network interface 1110 a make and model of the electric vehicle 1600 and an electric vehicle charger type and computing at the processor 1130 of the server 1100 the estimated speed of charging of the electric vehicle 1600 further considering the make and model of the electric vehicle 1600 and the electric vehicle charger type. The server 1100 can infer the battery type based on the make and model of the electric vehicle 1600. Based on the battery type and the type of electric vehicle charger 1500, the server 1100 can estimate the charging speed.

Optionally, computing the estimated speed of charging may be further performed based on a battery usage of the battery of the electric vehicle 1600, the battery usage being received at the server 1100 through the network interface 1110 from the driver computing device 1400. The driver reads off the battery usage from the display panel of the electric vehicle 1600 and enters the battery usage into the driver computing device 1400. The driver computing device 1400 sends the battery usage towards the server 1100 via the network 1200. Alternatively, the driver computing device 1400 is integrated with or connected to the electric vehicle 1600 and automatically determines the battery usage.

Optionally, computing the estimated speed of charging may further be performed based on a battery temperature of the battery of the electric vehicle 1600, the battery temperature being received at the server 1100 through the network interface 1110 from the driver computing device 1400. Alternatively, the host computing device 1300 could automatically determine the battery temperature if it is connected to the electric vehicle charger 1500, which is connected to the electric vehicle 1600. In this case, the host computing device 1300 would send the battery temperature towards the server 1100 via the network 1200.

Optionally, the driver computing device 1400 may be a driver mobile device and the host computing device 1300 may be a host computer or a host mobile device.

Optionally, the estimated cost is computed 2020 at the server 1100 by the processor 1130 using a function, the function being linear with respect to electricity provided. The electricity provided corresponds to the electricity level after charging minus the electricity level before charging. For example, this is particularly relevant when the price of electricity is constant throughout the charging.

Optionally, the function used to calculate the cost estimate may further include a host fee and a service provider fee, for example, as follows:

Cost Estimate=(Battery Level After−Battery Level Before)×Price of Electricity×Charging Time×Host Fee×Service Provider Fee

In this case, the host fee and the service provider fee are expressed as percentages. Alternatively, the host fee and service provider fee could be dollar amounts added on to the cost estimate. The host fee is an amount that goes to the host as compensation above the cost of providing the electricity to incentivize hosts to share their electric vehicle chargers. The service provider fee is an amount that goes towards compensating the service provider that operates the server 1100.

The estimated cost is computed 2020 at the server 1100 by the processor 1130 using an exponential or logarithmic function with respect to electricity provided. The electricity provided corresponds to the electricity level after charging minus the electricity level before charging. For example, this is particularly relevant when the price of electricity increases exponentially or logarithmically as electricity is consumed.

Optionally, the estimated cost may be computed 2020 at the server 1100 by the processor 1130 using a step function with respect to electricity provided. The electricity provided corresponds to the electricity level after charging minus the electricity level before charging. For example, this is particularly useful when the price of electricity increases in a step-wise fashion the more electricity is consumed. That is, there is a first price for the electricity if the amount of electricity consumed is between a first amount and a second amount, a second price for the electricity if the amount of electricity consumed is between a second amount and a third amount, and so on.

Optionally, the at least one charging time indicator may comprises:
a first indicator that charging of the electric vehicle 1600 at the electric vehicle charger 1500 has started, a first time being associated therewith;
a second indicator that charging of the electric vehicle 1600 at the electric vehicle charger 1500 has stopped, a second time being associated therewith; and
a charging time computed by subtracting the first time from the second time.

Optionally, the method 2000 may further comprise, upon determination that the price of electricity is unobtainable dynamically at the server 1100, setting (not shown) the price of electricity to a default price of electricity. For example, when the server obtains the price of electricity via the network 1200 from a third party server (not shown) operated by the electricity provider, and the server is inaccessible, the server 1100 may then use a default price of electricity stored on the storage module 1150. Alternatively, or in addition, the server 1100 may have a plurality of default prices, one for each geographical location, stored in a lookup table on the storage module 1150. The default price may be a running average or a maximum of historical electricity prices for a particular geographical location.

Optionally, the method 2000 may further comprise, upon determination that the battery level before charging is unobtainable dynamically at the server 1100, setting (not shown) the battery level before charging to a default value. For example, the driver may fail to enter the battery level before charging into the driver computing device 1400, or the driver computing device 1400 may fail to automatically read the battery level before charging. The default value for the battery level before charging could be empty, or alternatively it could be the average or typical battery level before charging of electric vehicles.

Optionally, the method 2000 may further comprise, upon determination that the battery level after charging is unobtainable dynamically at the server 1100, setting (not shown) the battery level after charging to a default value. For example, the driver may fail to enter the battery level after charging into the driver computing device 1400, or the driver computing device 1400 may fail to automatically read the battery level after charging. The default value for the battery level after charging could be full, or alternatively it could be the average or typical battery level after charging of electric vehicles.

Optionally, the method 2000 may further comprise, upon determination that the at least one charging time indicator is unobtainable dynamically at the server 1100, setting (not shown) a charging time of the electric vehicle 1600 at the electric vehicle charger 1500 from the at least one charging time indicator to a default value. For example, the driver may fail to enter the check-in and/or the check-out time into the driver computing device 1400, or the driver computing device 1400 may fail to automatically record the check-in and/or the check-out time. The server 1100 may then use a default charging time stored on the storage module 1150 of the server 1100. The default charging time may be a static value. Alternatively, the default charging time may be the average charging times for all electric vehicles using the server, dynamically updated over time. As a further alternative, there may be multiple average charging times, one for each vehicle make and model.

A skilled person will understand that the order of the steps in the method 2000 may be changed without affecting the nature of the invention.

The processor modules 1130, 1330, and 1430 may each represent a single processor with one or more processor cores or an array of processors, each comprising one or more processor cores. The memory modules 1120, 1320, and 1420 may each comprise various types of memory (different standardized or kinds of Random Access Memory (RAM) modules, memory cards, Read-Only Memory (ROM) modules, programmable ROM, etc.). The storage modules 1150, 1350, and 1450 may each represent one or more logical or physical as well as local or remote hard disk drive (HDD) (or an array thereof). The storage modules 1150, 1350, and 1450 may each further represent a local or remote database made accessible to the network 1200 by a standardized or proprietary interface. The network interface modules 1110, 1310, and 1410 each represents at least one physical interface that can be used to communicate with other network nodes. The network interface modules 1110, 1310, and 1410 may be made visible to the other modules of the network nodes 1100, 1300, and 1400 through one or more logical interfaces. The actual stacks of protocols used by the physical network interface(s) and/or logical network interface(s) of the network interface modules 1110, 1310, and 1410 do not affect the teachings of the present invention. The variants of processor modules 1130, 1330, and 1430, memory modules 1120, 1320, and 1420, network interface modules 1110, 1310, and 1410 and storage modules 1150, 1350, and 1450 usable in the context of the present invention will be readily apparent to persons skilled in the art. Likewise, even though explicit mentions of the memory modules 1120, 1320, and 1420 and/or the processor modules 1130, 1330, and 1430 are not made throughout the description of the present examples, persons skilled in the art will readily recognize that such modules are used in conjunction with other modules of the network nodes 1100, 1300, and 1400 to perform routine as well as innovative steps related to the present invention.

Various network links may be implicitly or explicitly used in the context of the present invention. While a link may be depicted as a wireless link, it could also be embodied as a wired link using a coaxial cable, an optical fiber, a category 5 cable, and the like. A wired or wireless access point (not shown) may be present on the link between. Likewise, any number of routers (not shown) may be present and part of the link, which may further pass through the Internet.

The present invention is not affected by the way the different modules exchange information between them. For instance, the memory modules and the processor modules within any given device could be connected by a parallel bus, but could also be connected by a serial connection or involve an intermediate module (not shown) without affecting the teachings of the present invention.

A method is generally conceived to be a self-consistent sequence of steps leading to a desired result. These steps require physical manipulations of physical quantities. Usually, though not necessarily, these quantities take the form of electrical or magnetic/electromagnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for estimating a cost of electricity provided to an electric vehicle, the method comprising:
at a server, obtaining a host geographical location and at least one charging time indicator associated with charging an electric vehicle at an electric vehicle charger, and storing the host geographical location and the at least one charging time indicator on a storage module of the server;
at the server, computing at a processor of the server a price of electricity based on the host geographical location;
at the server, absent a measurement of electricity provided to the electric vehicle while charging at the electric vehicle charger, computing at the processor of the server an estimated cost of the electricity provided to the electric vehicle while charging at the electric vehicle charger based on one or more physical characteristics of a battery of the electric vehicle, the price of electricity and the at least one charging time indicator, wherein the one or more physical characteristics of the battery comprise at least one of a battery level before charging and a battery level after charging; and
determining a payment amount taking into consideration the estimated cost of electricity provided to the electric vehicle.

2. The method of claim 1, further comprising, from the server, sending, through a network interface of the server, the payment amount towards a host computing device for display on a user interface thereof and towards a driver computing device for display on a driver user interface thereof.

3. The method of claim 1, wherein computing the price of electricity is further based on a time of day at the host geographical location or a host energy consumption pattern applicable to a host.

4. The method of claim 1, wherein computing the price of electricity comprises retrieving the price of electricity from the storage module of the server.

5. The method of claim 1, further comprising, at the server, processing using the processor of the server a payment equal to the payment amount from a driver associated with a driver computing device to a host associated with a host computing device.

6. The method of claim 1, further comprising, at the server, receiving the one or more physical characteristics of the battery through the network interface and storing the one or more physical characteristics of the battery on the storage module, the one or more physical characteristics of the battery being provided to a driver computing device through a driver user interface thereof.

7. The method of claim 1, further comprising computing at the processor of the server the battery level after charging based on the battery level before charging, the at least one charging time indicator, and an estimated speed of charging of the electric vehicle.

8. The method of claim 7, further comprising receiving at the server through the network interface a make and model of the electric vehicle and an electric vehicle charger type and computing at the processor of the server the estimated speed of charging of the electric vehicle further considering the make and model of the electric vehicle and the electric vehicle charger type.

9. The method of claim 8, wherein computing the estimated speed of charging is further performed based on a battery usage of the battery of the electric vehicle, the battery usage being received at the server through the network interface from a driver computing device.

10. The method of claim 8, wherein computing the estimated speed of charging is further performed based on a battery temperature of the battery of the electric vehicle, the battery temperature being received at the server through the network interface from a driver computing device.

11. The method of claim 1, wherein the estimated cost of the electricity provided to the electric vehicle is computed using a function, the function being:
Cost Estimate=(Battery Level After−Battery Level Before)×Price of Electricity×Charging Time

12. A server for estimating a cost of electricity provided to an electric vehicle, the server comprising:
a network interface module for interfacing with a host computing device and a driver computing device through a network, wherein the network interface is for:
obtaining a host geographical location and at least one charging time indicator associated with charging an electric vehicle at an electric vehicle charger;
a storage module for storing the host geographical location and the at least one charging time indicator; and
a processor module for:
computing a price of electricity based on the host geographical location;
absent a measurement of electricity provided to the electric vehicle while charging at the electric vehicle charger, computing an estimated cost of the electricity provided to the electric vehicle while charging at the electric vehicle charger based on one or more physical characteristics of a battery of the electric vehicle, the price of electricity and the at least one charging time indicator, wherein the one or more physical characteristics of the battery comprise at least one of a battery level before charging and a battery level after charging; and
determining a payment amount taking into consideration the estimated cost of electricity provided to the electric vehicle.

13. The server of claim 12, wherein the network interface is further for:
sending the payment amount towards the host computing device for display on a user interface thereof, and
sending the payment amount towards the driver computing device for display on a driver user interface thereof.

14. The server of claim 12, wherein computing the price of electricity is further based on a time of day at the host geographical location or a host energy consumption pattern applicable to a host.

15. The server of claim 12, wherein computing the price of electricity comprises retrieving the price of electricity from the storage module of the server.

16. The server of claim 12, wherein the network interface module is further for receiving the one or more physical characteristics of the battery, the one or more physical characteristics of the battery being provided to the driver computing device through a driver user interface thereof.

17. A system for estimating a cost of electricity provided to an electric vehicle, the system comprising:
a network comprising a server, a host computing device, and a driver computing device;
the server obtains a host geographical location and at least one charging time indicator associated with charging an electric vehicle at an electric vehicle charger, and stores the host geographical location and the at least one charging time indicator on a storage module of the server;
the server computes at a processor of the server a price of electricity based on the host geographical location;
the server, absent a measurement of electricity provided to the electric vehicle while charging at the electric vehicle charger, computes at the processor of the server an estimated cost of the electricity provided to the electric vehicle while charging at the electric vehicle charger based on one or more physical characteristics of a battery of the electric vehicle, the price of electricity and the at least one charging time indicator, wherein the one or more physical characteristics of the battery comprise at least one of a battery level before charging and a battery level after charging; and
the server determines a payment amount taking into consideration the estimated cost of electricity provided to the electric vehicle.

18. The system of claim 17, wherein the server sends through a network interface of the server the payment amount towards the host computing device for display on a user interface thereof and towards the driver computing device for display on a driver user interface thereof.

19. The system of claim 17, wherein computing the price of electricity is further based on a time of day at the host geographical location or a host energy consumption pattern applicable to a host.

20. The system of claim 17, wherein the server receives the one or more physical characteristics of the battery through the network interface and stores the one or more physical characteristics of the battery on the storage module, the one or more physical characteristics of the battery being provided to the driver computing device through the driver user interface thereof.
